(19) United States
(12) Patent Application Publication
(10) Pub. No.: US 2010/0128044 A1
(43) Pub. Date: May 27, 2010

(54) DATA PROCESSING CIRCUIT AND DISPLAY USING THE SAME

(75) Inventor: Wen-Hao YU, Hsinchu-City (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., Hsinchu (TW)

(21) Appl. No.: 12/553,716

(22) Filed: Sep. 3, 2009

(30) Foreign Application Priority Data
Nov. 24, 2008 (TW) 97145377

(51) Int. Cl. G06F 3/038; G09G 5/36

(52) U.S. Cl. 345/545; 345/213

(57) ABSTRACT

A data processing circuit for driving a display panel is provided. The data processing circuit includes a main control circuit and a display driver. The main control circuit includes a processor for providing N*M pieces of image data. The display driver includes a display controller, a frame buffer and a scan register. The display controller stores the N*M pieces of image data in the frame buffer and subsequently scans the image data into the corresponding regions of the display panel. The frame buffer records and indicates the row and column positions of the pixel on the display panel currently scanned by the display controller. The processor can read the scan register to obtain the scan information and determines the writing timing of the frame buffer according to the scan information in order to synchronize the main control circuit and the display driver.

This application claims the benefit of Taiwan application Serial No. 97145377, filed Nov. 24, 2008, the subject matter of which is incorporated herein by reference.

### BACKGROUND OF THE INVENTION

1. Field of the Invention

The invention relates in general to a data processing circuit, and more particularly, to a data processing circuit for eliminating a tearing effect of a display.

2. Description of the Related Art

In current technology, a display system normally includes a main control circuit, a display driver and a display panel. For example, the display panel can be a liquid crystal display panel. The display driver includes a frame buffer for buffering the image data provided by the main control circuit. The display driver is further for providing the image data buffered in the frame buffer to the liquid crystal display panel to display the corresponding frame.

Generally speaking, the operation of the main control circuit providing the image data to the frame buffer should be synchronous with the operation of the frame buffer providing the image data to the liquid crystal display panel to avoid a tearing effect of the image displayed on the liquid crystal display panel. Therefore, how to effectively synchronize the input and output operations of the frame buffer has become an essential goal of the relevant industrial's endeavor.

### SUMMARY OF THE INVENTION

The invention is directed to a data processing circuit. The data processing circuit includes a main control circuit obtaining scan information of the frame buffer by reading a register installed in a driver integrated circuit (IC) of the display and accordingly synchronizing the writing and reading operations of the frame buffer.

According to a first aspect of the present invention, a data processing circuit is provided. The data processing circuit is for driving a display panel to display an image frame, and the display panel comprises N*M pixels, wherein N, M are natural numbers larger than 1. The data processing circuit comprises a main control circuit and a display driver. The main control circuit comprises a processor for providing N*M pieces of image data. The display driver comprises a display controller, a frame buffer and a scan register. The display controller is for receiving and providing the N*M pieces of image data. The frame buffer is for buffering the N*M pieces of image data provided by the display controller and outputting the N*M pieces of image data in a transmission period to drive the corresponding pixels of the display panel. The scan register is for recording scan information, wherein the scan information indicates the image data being currently outputted by the frame buffer. The processor is further used for reading the scan register to obtain the scan information and adjusting transmission of the image data according to the scan information.

According to a second aspect of the present invention, a display is provided. The display comprises a display panel with N*M pixels, a main control circuit and a display driver, wherein N, M are natural numbers larger than 1. The main control circuit comprises a processor for providing N*M pieces of image data. The display driver comprises a display controller, a frame buffer and a scan register. The display controller is for receiving and providing the N*M pieces of image data. The frame buffer is for buffering the N*M pieces of image data provided by the display controller and outputting the N*M pieces of image data in a transmission period to drive the corresponding pixels of the display panel. The scan register is for recording scan information, wherein the scan information indicates the image data currently outputted by the frame buffer. The processor is further used for reading the scan register to obtain the scan information and adjusting transmission of the image data according to the scan information.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a display according to a preferred embodiment of the invention.

FIG. 2 is a signal timing diagram of the display in FIG. 1.

### DETAILED DESCRIPTION OF THE INVENTION

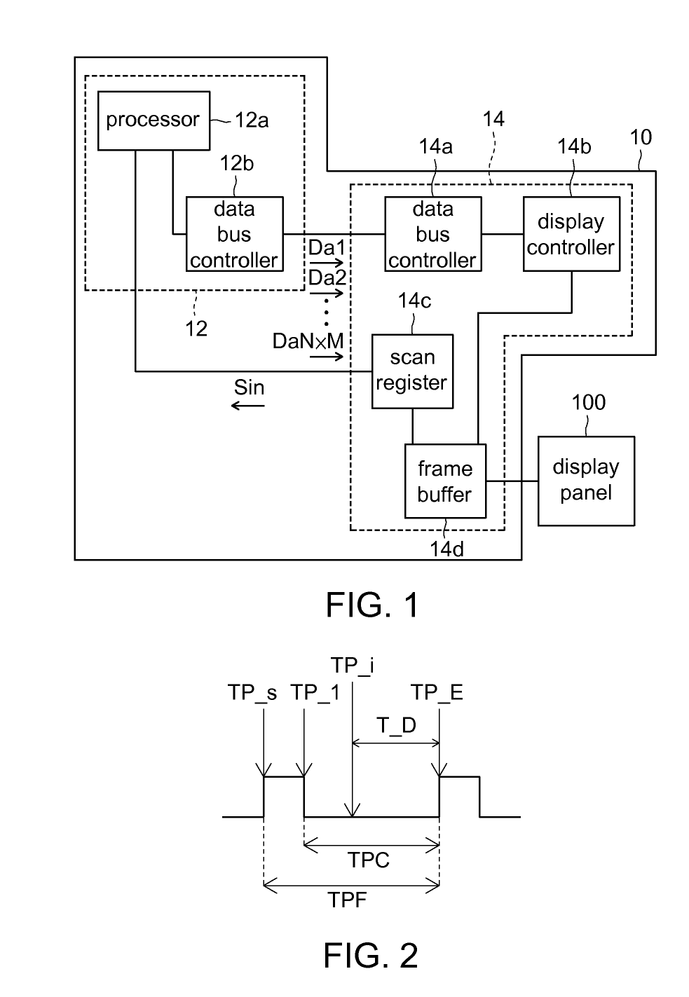

Referring to FIG. 1, a block diagram of a display according to a preferred embodiment of the invention is shown. The display 1 includes a data processing circuit 10 and a display panel 100. The data processing circuit 10 includes a main control circuit 12 and a display driver 14. For example, the display panel 100 is a liquid crystal display panel, which includes a pixel array having N*M pixels, wherein N, M are natural numbers larger than 1.

The main control circuit 12 includes a processor 12a and a data bus controller 12b. The main control circuit 12 provides N*M pieces of image data Da1, Da2, . . . , DaN, . . . , DaN*M to the display driver 14. In the embodiment, the N*M pieces of image are respectively corresponding to the first row of pixels to the N^{th} row of pixels in the display panel 100 for displaying a complete frame, and it is supposed a non-display time between two frames is a period of time for displaying L rows of pixels, wherein L is an integer larger than or equal to zero.

The display driver 14 includes a data bus controller 14a, a display controller 14b, a scan register 14c and a frame buffer 14d. The display controller 14b is for receiving and storing the N*M pieces of image data Da1˜DaN*M provided by the main control circuit 12 into the frame buffer 14d and outputting the image data in the next frame period to drive the corresponding pixels of the liquid crystal panel.

The scan register 14c is coupled to the frame buffer 14d for buffering a scan information Sin. The scan information Sin indicates which row of pixels in the display panel 100 is currently being scanned by the frame buffer 14d.

The processor 12a is for reading the scan register 14c and determining the time for outputting the next N*M pieces of image data according to the scan information Sin such that the operation of inputting the pixel data to the frame buffer 14d and the operation of outputting the pixel data from the frame buffer 14d to the display panel 100 can be synchronized.

For example, referring to FIG. 2, a signal timing diagram of the display 1 in FIG. 1 is shown. In FIG. 2, a complete frame period, symbolized as TPF, includes a period of display time TPC and a period of non-display time TPF-TPC. The display time TPC includes a scan time for scanning N rows of pixels, and the non-display time is supposed to be a scan time for scanning L rows of pixels.

The processor 12a reads the scan register 14c to obtain the pixel data of the i^{th} row of pixels in the display panel 100, which is currently outputted by the frame buffer 14d. Therefore, the processor 12a can easily obtain the following estimation according to the value i and the row numbers N and L:

I. The next frame period of the display driver will start after a time period for scanning (N-i) rows of pixels.

II. The first row of pixels in the next frame period of the display driver will start to be scanned after a time period for scanning (L+N−i) rows of pixels.

The main control circuit 12 can determine the transmission period of the next frame (the next N*M pieces of image data) according to the above estimation and the timing of the main control circuit 12. Therefore, the N*M pieces of image data can be outputted at the correct time point to synchronize the input and output operations of the frame buffer 14d, thereby avoiding occurrence of the tearing effect.

However, the invention is not limited to the above operation. For example, after the processor 12a obtains the current scan condition of the display panel 100 according to the scan information, the output condition (output timing) of the processor 12a as outputting the image data can also be adjusted timely to synchronize the input and output operations of the frame buffer 14d. All the alternatives are not apart from the scope of the invention.

Besides, in the embodiment of FIG. 1, the main control circuit 12 and the display driver 14 further include data bus controllers 12b and 14a, respectively. The processor 12a of the main control circuit 12 can effectively provide the pixel data Da1˜DaN to the display controller 14b and the frame buffer 14d of the display driver 14 through a bus between the data bus controllers 12b and 14a.

As mentioned above, in the embodiment, the main control circuit 12 reads the scan information stored in the scan register 14c to obtain the current scan position of the display panel 100 and accordingly control the timing of providing the pixel data to the frame buffer such that the writing and reading operations of the frame buffer can be synchronized. Therefore, the data processing circuit 10 can synchronize the writing and reading operations of the frame buffer to avoid the above-mentioned tearing effect.

Further, in the embodiment, owing that the data processing circuit 10 just needs an extra register (the scan register 14c) for storing the scan information, the data processing circuit 10 can directly apply the currently-existing structure of data processing and main control circuits to synchronize the writing and reading operations of the frame buffer without needing too much modification of the hardware structure. Therefore, the data processing circuit of the invention not only prevents the prior-art tearing effect, but also reduces the cost in circuit design.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data processing circuit, for driving a display panel to display an image frame, the display panel comprising N*M pixels, N, M being natural numbers larger than 1, the data processing circuit comprising:
a main control circuit, comprising:
a processor, for providing N*M pieces of image data; and
a display driver, comprising:
a display controller, for receiving and providing the N*M pieces of image data;
a frame buffer, for buffering the N*M pieces of image data provided by the display controller and outputting the N*M pieces of image data in a transmission period to drive the corresponding pixels of the display panel; and
a scan register, for recording a scan information, wherein the scan information indicates the image data currently outputted by the frame buffer;
wherein the processor is further used for reading the scan register to obtain the scan information and adjusting transmission of the image data according to the scan information.

2. The data processing circuit according to claim 1, wherein the main control circuit further comprises:
a first data bus controller, controlled by the processor and providing the N*M pieces of image data to the display driver via a bus.

3. The data processing circuit according to claim 2, wherein the display driver further comprises:
a second data bus controller, for receiving the N*M pieces of image data via the bus and providing the N*M pieces of image data to the frame buffer.

4. The data processing circuit according to claim 1, wherein the processor determines a transmission period of next N*M pieces of image data according to the scan information.

5. A display, comprising:
a display panel, comprising N*M pixels, N, M being natural numbers larger than 1;
a main control circuit, comprising:
a processor, for providing N*M pieces of image data; and
a display driver, comprising:
a display controller, for receiving and providing the N*M pieces of image data;
a frame buffer, for buffering the N*M pieces of image data provided by the display controller and outputting the N*M pieces of image data in a transmission period to drive the corresponding pixels of the display panel; and
a scan register, for recording a scan information, wherein the scan information indicates the image data currently outputted by the frame buffer;
wherein the processor is further used for reading the scan register to obtain the scan information and adjusting transmission of the image data according to the scan information.

6. The display according to claim 5, wherein the main control circuit further comprises:
a first data bus controller, controlled by the processor and providing the N*M pieces of image data to the display driver via a bus.

7. The display according to claim 6, wherein the display driver further comprises:
a second data bus controller, for receiving the N*M pieces of image data via the bus and providing the N*M pieces of image data to the frame buffer.

8. The display according to claim 5, wherein the processor determines a transmission period of next N*M pieces of image data according to the scan information.
